(19) United States
(12) Patent Application Publication
(10) Pub. No.: US 2026/0050766 A1
(43) Pub. Date: Feb. 19, 2026

(54) EFFICIENT ATTENTION IN TRANSFORMER NEURAL NETWORKS USING STATE SPACE MODELS

(71) Applicant: QUALCOMM Incorporated, San Diego, CA (US)

(72) Inventors: Mukul GAGRANI, Milpitas, CA (US); Junyoung PARK, Palo Alto, CA (US); Raghavv GOEL, San Diego, CA (US); Dalton James JONES, Cupertino, CA (US); Wonseok JEON, San Diego, CA (US); Matthew James MORSE, Astoria, NY (US); Matthew Harper LANGSTON, Beacon, NY (US); Mingu LEE, San Diego, CA (US); Christopher LOTT, San Diego, CA (US)

(21) Appl. No.: 19/012,254

(22) Filed: Jan. 7, 2025

Related U.S. Application Data
(60) Provisional application No. 63/684,232, filed on Aug. 16, 2024.

(51) Int. Cl. G06N 3/045; G06N 3/0475; G06N 3/09

(52) U.S. Cl. CPC G06N 3/045; G06N 3/0475; G06N 3/09

(57) ABSTRACT

Certain aspects of the present disclosure provide techniques and apparatus for efficient inferencing using a machine learning model. An example method generally includes receiving an input including a set of tokens for processing by a transformer neural network. The set of tokens for processing by the transformer neural network is partitioned into a first set of tokens and a second set of tokens. Using at least one state space model, at least one compressed token representing the first set of tokens is generated. An output token is generated, using the transformer neural network, based on the compressed token and the second set of tokens. A response to the input is generated based on the output token.

### CROSS-REFERENCE TO RELATED APPLICATIONS

This application claims priority to and benefit of U.S. Provisional Patent Application Ser. No. 63/684,232, entitled “Efficient Attention in Transformer Neural Networks Using State Space Models,” filed Aug. 16, 2024, and assigned to the assignee hereof, the entire contents of which are hereby incorporated by reference.

### INTRODUCTION

Aspects of the present disclosure relate to neural networks, and more specifically, to efficient execution of attention-based operations in neural networks.

Machine learning models, such as convolutional neural networks, transformer neural networks, and the like, are used for various tasks, such as object detection in visual content, segmentation of visual content, processing data having objects with different dimensions, generating natural language responses to natural language queries, and the like. In order to perform these tasks, these machine learning models may be trained to perform various operations internally (e.g., to map input data into representations in a latent space based on which an inference can be performed, to project inputs into tokens (e.g., key, query, and value tokens in a transformer neural network), apply an activation function to data generated by the machine learning model, etc.). These operations may vary in complexity, from relatively simple mathematical operations (e.g., addition, multiplication, etc.) to complex mathematical operations that involve significant amounts of processor time and memory utilization.

### BRIEF SUMMARY

Certain aspects of the present disclosure provide a processor-implemented method for efficient inferencing using a machine learning model. An example method generally includes receiving an input including a set of tokens for processing by a transformer neural network. The set of tokens for processing by the transformer neural network is partitioned into a first set of tokens and a second set of tokens. Using at least one state space model, at least one compressed token representing the first set of tokens is generated. An output token is generated, using the transformer neural network, based on the compressed token and the second set of tokens. A response to the input is generated based on the output token.

Certain aspects of the present disclosure provide a processor-implemented method for training a machine learning model to generate a compressed token for use by a transformer neural network in inferencing operations. An example method generally includes obtaining a training data set including a plurality of token sets. Each token set generally includes an input token set and a ground-truth token associated with the input token set. A state space model is trained to represent the input token set using a compressed number of tokens based on a difference between tokens generated by the transformer neural network from compressed tokens representing input token sets in the training data set and corresponding ground-truth tokens associated with the input token sets in the training data set. The trained state space model is deployed.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example pipeline for efficient inferencing using a transformer neural network and token compression using a state space model, according to certain aspects of the present disclosure.

FIG. 2 illustrates an example pipeline for efficient inferencing using a transformer neural network and token compression using multiple state space models, according to certain aspects of the present disclosure.

FIG. 3 illustrates example operations for efficiently performing inferencing operations in a transformer neural network based on token compression using a state space model, according to certain aspects of the present disclosure.

FIG. 4 illustrates example operations for training a state space model to compress tokens into at least one compressed token for processing in a transformer neural network, according to certain aspects of the present disclosure.

FIG. 5 depicts an example processing system configured to perform various aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for efficiently performing inferencing operations using transformer neural networks.

In a wide variety of machine learning model architectures, attention (e.g., self-attention) is used to generate model output. For example, many models (such as large language models (LLMs), large vision models (LVMs), and the like) use transformer-based self-attention operations. Generating attention scores during data processing generally includes generating a set of intermediate data (e.g., tensors) for each element of the data (e.g., each token in an input sequence). For example, for each token, the model may compute a key tensor (also referred to in some aspects as the “keys”), a value tensor (also referred to in some aspects as the “values”), and a query tensor (also referred to in some aspects as the “queries”). As used herein, a “token” can generally correspond to any logical element of data. For example, in the case of LLMs, the tokens are generally words, phrases, characters, symbols, or portions thereof. In the case of LVMs, the tokens may correspond to pixels or blocks of pixels (e.g., in an image).

Attention is generally computed for each token with respect to one or more other tokens based on the respective intermediate tensors for each token. Because attention computation is based on intermediate tensors, intermediate data (or intermediate tensor) caching may be used to reduce computational expense of the model (e.g., to cache intermediate data that will be used to process subsequent data). For example, in some models, the keys and values of one or more tokens may be cached (referred to in some aspects as “key-value caching” or “KV caching”) for reuse in generating attention data for subsequent tokens. As used herein, a “cache” may generally refer to any memory used to store the intermediate data during processing. Similarly, “caching” data may refer to storing the data in any such memory. Further, “evicting” data from a cache may refer to removing or deleting the data from the cache, marking the corresponding memory address space as unused, overwriting the data in the cache, and the like.

While key-value (KV) caches can significantly reduce the computational expense of generating model output, these caches grow rapidly and often become a severe memory bottleneck. Such bottlenecks, which may involve movement of large amounts of data between smaller, faster data repositories and larger, slower data repositories (e.g., between processor cache and random access memory, between random access memory and page files in persistent storage, etc.), with the attendant latencies involved in performing such movements, may be encountered rapidly when machine learning models start executing operations on devices with limited memory (e.g., mobile phones, tablet computers, laptop computers, Internet of Things (IoT) devices, edge devices in a communications network, etc.) and/or when performing long-context generation (e.g., generating output based on a relatively large input prompt). For example, the memory consumed by the KV cache can exceed the footprint of the model itself (even for large models having millions or billions of parameters). Further, because caching intermediate tensors at each layer of the model may be useful in reducing the computational complexity of machine learning model operations, as discussed above, the caching of these intermediate tensors may further exacerbate the problems caused by memory constraints.

To reduce the size of caches in machine learning models, such as KV caches in transformer neural networks, selective caching (e.g., where a subset of the intermediate data, such as data for a subset of the tokens, is cached, and/or where a subset of the intermediate data is evicted or removed from the cache during processing) may be used. In some aspects, removing the intermediate data associated with a given token may be referred to as “evicting” the token or as “token eviction.” For example, if the key tensor and value tensor of a given token are removed from the cache, it may be said that the given token was evicted from the cache. While token eviction may allow for reductions in the number of tokens included in a KV cache, the removal of a token from the KV cache at a given round of inferencing makes the token unavailable for all future rounds of inferencing. Thus, the eviction or removal of a token from a KV cache may have a negative impact on inferencing accuracy, as contextual data that may be relevant for, or at least inform the results of, future inferencing rounds may be lost with each token evicted from the KV cache.

Aspects of the present disclosure provide techniques for reducing the computational cost of processing input data in transformer neural networks while minimizing, or at least reducing, the amount of data lost in efficiently processing data in transformer neural networks. As discussed in further detail herein, to reduce the computational expense involved in inferencing operations using a transformer neural network, tokens involved in inferencing operations may be split into a first set of tokens and a second set of tokens, with the second set of tokens including the most recent n tokens generated by a transformer neural network and the first set of tokens including tokens older than the most recent n tokens generated by the transformer neural network. The first set of tokens may be compressed into a compressed token representing the first set of tokens using a state space model and prepended to the second set of tokens. As used herein, the compressed token may include an embedding representation of the first set of tokens. The compressed token and the second set of tokens may be input into the transformer neural network for use in generating an output token in a new inferencing round. By compressing tokens using a state space model prior to generating an inference in a subsequent round of inferencing, certain aspects of the present disclosure may reduce the size of KV caches used by the transformer neural network to generate output tokens for a given input while maintaining contextual information that may be useful in subsequent inferencing rounds. Thus, fewer compute resources may be utilized to complete various tasks for which transformer neural networks are used, while maintaining or improving inferencing accuracy relative to techniques in which tokens remain uncompressed during processing within a transformer neural network and improving inferencing accuracy relative to techniques in which intermediate tensors (e.g., keys and values in a KV cache) are evicted during inferencing operations.

### Example State Space Models

A state space model generally represents a sequence of data using a linear dynamic system. Generally, state space models map an input xₜ∈ [symbol] at a time step t to an output yₜ∈ [symbol] via a latent state hₜ∈ [symbol] , where N corresponds to the number of dimensions in the latent space into which the input xₜ is mapped to the output yₜ via the latent state hₜ. The latent state hₜ may be represented by the equation:

$${h}_{t} = \overline{A} {h}_{t - 1} + \overline{B} {x}_{t}$$

The output yₜ may be recovered from the latent state hₜ based on the equation:

$${y}_{t} = C {h}_{t}$$

In other words, the output yₜ may be a linear function of the latent state hₜ. Ā and B̅ represent discrete parameters obtained from the learnable parameters A and B of the state space model, according to the equations:

$$\overline{A} = exp ( Δ A )$$

$$and$$

$$\overline{B} = {( Δ A )}^{- 1} ( exp ( Δ A ) - I ) \cdot Δ B$$

In the equations above, Δ represents a sampling interval, and A, B, C, and Δ are parameters that may be learned during training of a state space model.

Generally, a state space model may allow for the latent state representation hₜ of an input xₜ to be updated efficiently in a recurrent manner. That is, to generate the latent space representation hₜ₊₁ for the input xₜ₊₁ from the latent space representation hₜ of the input xₜ, the state space model can generate hₜ₊₁ as a function of processing the inputs hₜ and xₜ₊₁. In doing so, the latent space representation h may be updated via a process that executes in constant time (e.g., is O(1) complexity), which may be significantly less complex than the complexity involved in generating an output token using a transformer neural network (which may be a function that scales linearly (e.g., is O(n) complexity) when executed using a key-value cache. While state space models may allow for the generation of output tokens in response to an input like transformer-based models, state space models may generate lower-quality outputs than transformer-based models in certain tasks, such as in language modeling tasks. However, because state space models may allow for the state of a system to be accurately represented in a compressed form, state space models may allow for the compression of tokens in a KV cache used by a transformer neural network in inferencing tasks and may thus allow for efficient inferencing while maintaining inferencing accuracy relative to techniques in which tokens in the KV cache are uncompressed during the inferencing process.

### Example Inferencing Using Transformer Neural Networks and State-Space-Model-Based Token Compression

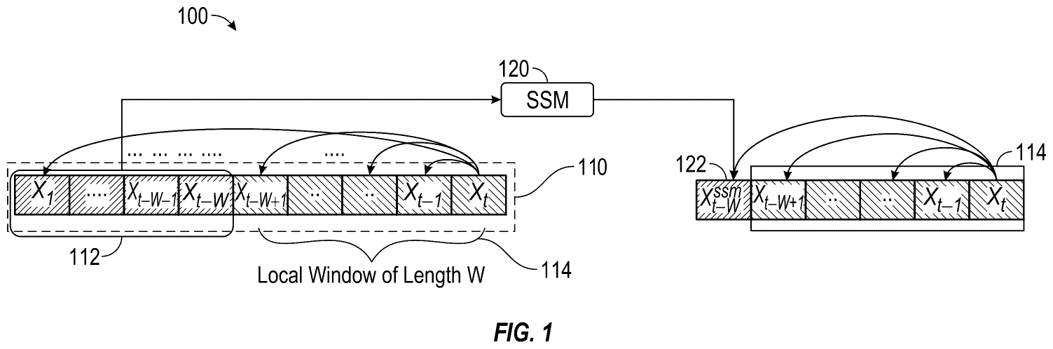

FIG. 1 illustrates an example pipeline 100 for efficient inferencing using a transformer neural network and token compressing using a state space model, according to certain aspects of the present disclosure.

As illustrated, in the pipeline 100, an input set of tokens 110 includes t tokens that include contextual information usable by a transformer neural network to generate the t+1^{th} token responding to an input prompt. Generally, the input set of tokens 110 may include a tokenized version of the input prompt and a sequence of tokens generated by the transformer neural network in response to the input prompt (if any tokens have been generated). Each token in the input set of tokens 110 may correspond, for example, to words or parts of words in an input prompt and, if any, words or parts of words generated by a transformer neural network to generate a textual response to a textual input query in examples in which the transformer neural network is a large language model. In other examples, tokens in the input set of tokens 110 may correspond to different portions of an image provided as an input into the transformer neural network and/or generated as an output of the transformer neural network in examples in which the transformer neural network is used in image processing tasks (e.g., generative fill, image generation from a textual prompt, modification of a base image based on a textual prompt, etc.).

When the input set of tokens 110 is processed by a transformer neural network, a dense self-attention block within the transformer neural network may calculate attention values for each token in the input set of tokens 110. As indicated by the arrows in the left-hand side of FIG. 1, a token Xₜ at time t attends to all the past tokens. However, as discussed above, self-attention incurs a significant computational expense that scales as the number of tokens in the input set of tokens 110 increases, as self-attention generally involves calculations performed over an ever-growing universe of tokens and key-value data. Further, the size of a key-value cache used in the transformer neural network to reduce repetitive computation may also scale as the size of the input set of tokens 110 increases. In some cases, the size of the key-value cache may grow larger than the size of the weights of the transformer neural network. Generally, the quadratic scaling of the size of the key-value cache may introduce a memory bottleneck from outgrowing the amount of temporary memory present on a computing device on which the pipeline 100 executes. This memory bottleneck in turn may negatively impact inferencing speed due to latencies involved in swapping data (e.g., key-value cache data) between different types of memory during inferencing time as such data is used to calculate self-attention and perform other tasks during the inferencing process. Such an impact may be experienced earlier on edge devices, such as smartphones, tablet computers, or the like, than on cloud computing instances, which typically have greater resources. Experiencing such impact earlier may impose constraints on the ability of these edge devices to perform inferencing operations or to do so while complying with power utilization or other computing resource utilization limits defined for these edge devices.

To reduce the computational expense (e.g., memory utilization, processor cycles, etc.) involved in computing self-attention in a transformer neural network and minimize, or at least reduce, latencies caused by swapping cached data into and out of system memory, certain aspects of the present disclosure reduce the number of tokens processed by the transformer neural network during inferencing rounds using a state space model and partitioning of the input set of tokens 110 into (i) a first set of tokens 112 that may be subject to compression and (ii) a second set of tokens 114 that may be preserved in their original forms for processing during the current inferencing round. Generally, the first set of tokens 112 may be disjoint from the second set of tokens 114. That is, the first set of tokens 112 may not include tokens included in the second set of tokens 114 so that data is not duplicated in the first and second sets of tokens 112, 114. For example, as illustrated, a window may be defined with size W for the second set of tokens 114. If the number of tokens in the input set of tokens 110 is smaller than W, then the input set of tokens 110 need not be partitioned, and inferencing operations using the transformer neural network may proceed based on the input set of tokens 110 without modifying the input set of tokens 110 (conceptually, the first set of tokens 112 would correspond to the null set, and the second set of tokens 114 would correspond to the input set of tokens 110). If, however, the number of tokens t exceeds W, then the input set of tokens 110 may be partitioned into the first set of tokens 112 and the second set of tokens 114. The first set of tokens 112 may include the tokens in the input set of tokens 110 with indices 1 through t-W, while the second set of tokens 114 may include the tokens in the input set of tokens 110 with indices t-W+1 through t.

To reduce the size of the key-value caches used during inferencing processes by the transformer neural network, while preserving the information contained in the first set of tokens 112, the first set of tokens 112 may be converted into a compressed token 122 via a trained state space model (SSM) 120. Generally, the compressed token 122 may be a key-value pair or other embedding representation that encodes the information of the tokens in the first set of tokens 112 (i.e., the tokens with indices 1 through t-W) in a more compact format (e.g., as a single token instead of t-W tokens). As a result, the input into the transformer neural network may be reduced from t tokens to the concatenation of the compressed token 122 and the second set of tokens 114, where the concatenation includes W+1 tokens as illustrated in FIG. 1. As indicated by the arrows in the right-hand side of FIG. 1 and in accordance with the teachings of the present disclosure, the SSM 120 augments the attention in the sense that a token Xₜ at time t attends to all the tokens in the local window of size W and to an additional token that is obtained by compressing the tokens X_{1:t-W} via the SSM.

Generally, a key-value pair representing the compressed token 122 may be recoverable based on the weight matrices Wₖ and Wᵥ of the transformer neural network. That is, for a compressed token 122 denoted as

$${X}_{t - W}^{ssm} = {f}_{ssm} ( {X}_{1 : t - W} ) ,$$

we key may be recovered according to the equation

$${k}_{t - W}^{ssm} = {W}_{k} {X}_{t - W}^{ssm} ,$$

and the corresponding value may be recovered according to the equation

$${v}_{t - W}^{ssm} = {W}_{v} {X}_{t - W}^{s s m} .$$

The compressed token may be designated as the token with index 0 in the input into the transformer neural network, and the tokens in the second set of tokens 114 may be designated as tokens with indices 1 through W in the input into the transformer neural network.

The SSM 120 may be trained to minimize, or at least reduce, a next token prediction loss. To train the SSM, a training data set of a sequence of input tokens mapped to a ground-truth output token associated with the sequence of input tokens (e.g., the output token generated by the transformer neural network for a given sequence of input tokens) may be generated. The SSM may be trained to generate a predicted output token based on a SSM representation of the sequence of input tokens, and the difference between the predicted output token and the ground-truth output token for a given sequence of input tokens may be backpropagated through the SSM to train the SSM. Generally, the weights of the transformer neural network for which the SSM is trained to generate compressed input tokens may be frozen, and the weights and other parameters of the SSM may be learned during the training process.

During inferencing, the compressed token 122 may be updated in a recurrent manner using the SSM 120. For example, FIG. 1 illustrates an inferencing pipeline at time t+1, resulting in the generation of a token Xₜ₊₁ based on a sequence of tokens up to time t. At time t+2, the token at index t-W+1 may be outside the window W. Thus, to allow for this token to be processed by the transformer neural network while maintaining the size of the input into the transformer neural network, the compressed token 122 may be updated recurrently by the SSM 120 to account for the information contained in the token X_{t-W+1}. The compressed token 122 at time t+2, which encodes information from the tokens with indices 1 through t+1, may be represented by the expression

$${X}_{t + 1}^{ssm} = {f}_{ssm} ( {X}_{t}^{ssm} , {X}_{t - W + 1} ) ,$$

where fₛₛₘ(⋅) represents a function corresponding to the SSM 120, and

$${X}_{t}^{s s m}$$

and X_{t-W+1} represent the inputs into the SSM 120 (e.g., the previously generated SSM token and the t-W+1^{th} token). By doing so, the number of tokens included in an input into the transformer neural network may remain bounded by the size of the window W plus 1. Thus, the data size of the key-value cache of the transformer neural network may also be capped such that the data size of the key-value cache remains constant-sized once the number of tokens included in the input set of tokens 110 exceeds W.

While FIG. 1 illustrates the use of a single compressed token 122 to represent tokens in the first set of tokens 112, it should be recognized that the first set of tokens 112 may be represented by any suitable number of compressed tokens. For example, each compressed token may correspond to a subset (or chunk) of tokens in the first set of tokens 112. Each subset may represent up to M tokens, with M being an arbitrarily defined number. In such an example, tokens with indices 1 through M may be represented by a first compressed token, tokens with indices M+1 through 2M may be represented by a second compressed token, and so on. In some aspects, the subsets of tokens based on which each compressed token is generated may be of different sizes. In generating a compressed token, the first token of M tokens based on which a compressed token is generated may be directly generated based on the output of the SSM 120 for the first token. The compressed token may be recurrently updated until the compressed token includes information from M tokens. For example,

$${X}_{M}^{ssm} = {f}_{ssm} ( {X}_{1} )$$

for the token with index 1,

$${x}_{M}^{ssm} = f ( {X}_{M}^{ssm} , {X}_{2} )$$

for the token with index 2, and so on, until

$${X}_{M}^{ssm}$$

encodes contextual information for tokens X₁ through X_{M}.

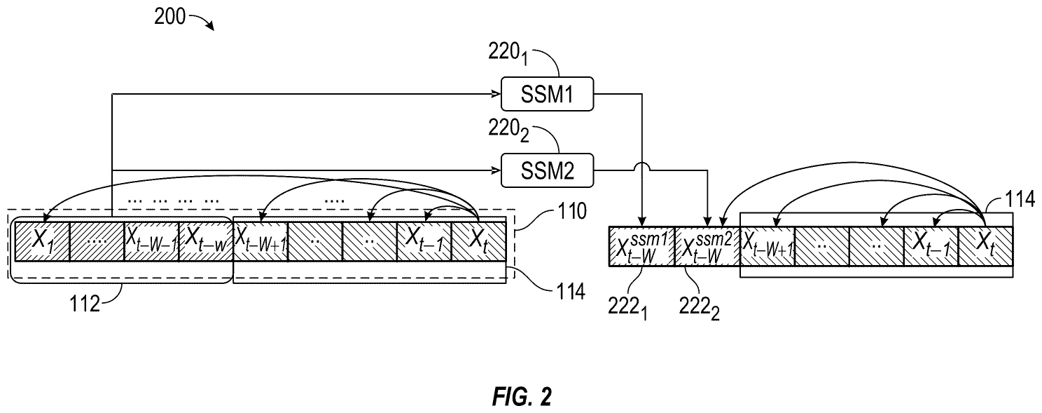

FIG. 2 illustrates an example pipeline 200 for efficient inferencing using a transformer neural network and token compressing using multiple state space models (SSMs), according to certain aspects of the present disclosure.

In the pipeline 200, multiple SSMs 220₁ and 220₂ (amongst others not illustrated in FIG. 2 in some cases) may be used to generate multiple compressed tokens 222₁ and 222₂ (amongst others not illustrated in FIG. 2 in some cases). As in FIG. 1, the input set of tokens 110 may be partitioned into a first set of tokens 112 and a second set of tokens 114 when the number of tokens in the input set of tokens 110 exceeds a defined window size W. The first set of tokens 112 may be input into each of the SSMs 220, which are deployed to generate compressed tokens for use by the transformer neural network. Each of the SSMs 220 may independently generate a respective compressed token 222 in parallel or substantially in parallel. Generally, using different SSMs 220 to generate different compressed tokens 222 may allow for the generation of key-value data with different contextual information based on how the SSMs 220 were trained.

Similar to FIG. 1, although FIG. 2 illustrates each SSM 220 generating a single compressed token 222 to represent tokens in the first set of tokens 112, it should be understood that each of the SSMs may generate any suitable number of compressed tokens. For example, each of the SSMs 220 may generate one or more compressed tokens, and the multiple SSMs may generate the same or different numbers of compressed tokens.

Generally, by using one or more SSMs (e.g., the SSM 120 illustrated in FIG. 1 and/or the SSMs 220 illustrated in FIG. 2) to generate compressed tokens that retain the contextual information for use in inferencing operations (e.g., self-attention calculation in a transformer layer of a generative artificial intelligence model such as a large language model (LLM), a large multimodal modal (LMM), or the like), certain aspects of the present disclosure may provide for reduced computational expense and faster inferencing speed than that achieved by techniques in which tokens are not compressed during the inferencing process while maintaining at least similar inference performance to techniques in which tokens are not compressed during the inferencing process. Further, certain aspects of the present disclosure may provide for increased inference accuracy (e.g., as measured by a perplexity metric that evaluates how well a language model predicts the next token in a sequence of text) than that achieved by techniques in which tokens or other information are evicted from a KV cache and thus unavailable for use in future inferencing rounds. Still further, because tokens outside a defined window W may be compressed so that the contextual information associated with these tokens can still be used during the inferencing process, certain aspects of the present disclosure may allow for the generation of longer responses using a generative artificial intelligence model. The defined ceiling on the number of tokens in a KV cache may, for example, allow for an unbounded sequence length for inputs into the generative artificial intelligence model.

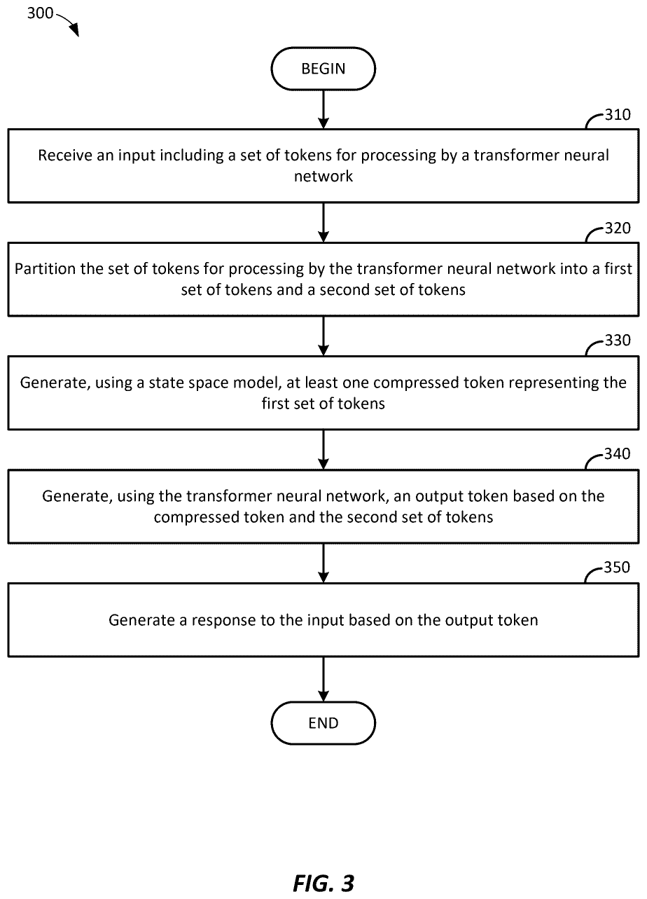

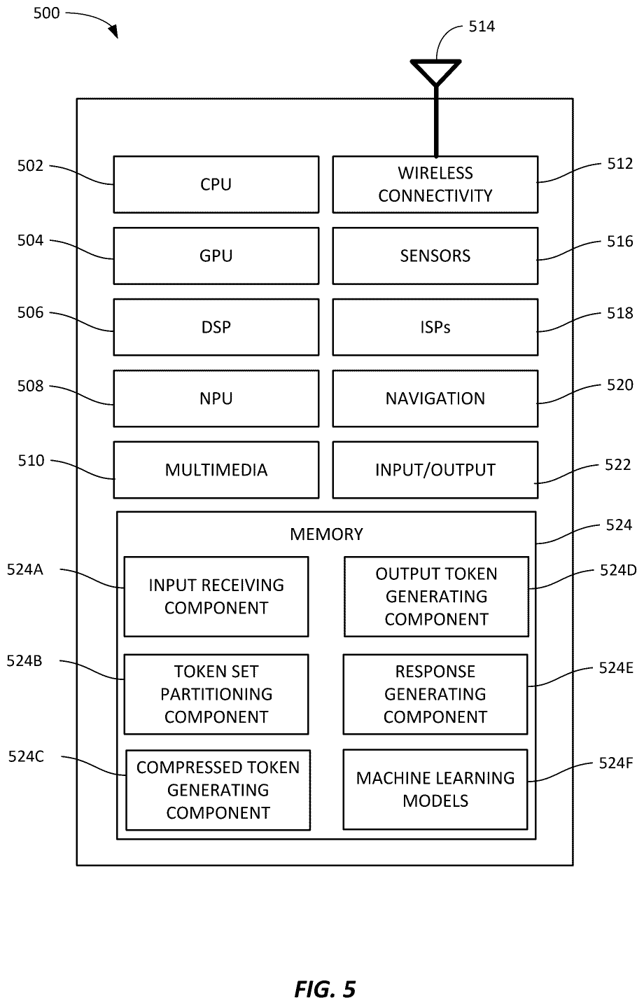

FIG. 3 illustrates example operations 300 for performing inferencing operations in a transformer neural network based on token compression using a state space model (e.g., the SSM 120 illustrated in FIG. 1 and/or the SSMs 220 illustrated in FIG. 2), according to certain aspects of the present disclosure. The operations 300 may be performed, for example, by a computing system on which a transformer neural network is deployed for processing input data, such as a user equipment (UE), a smartphone, a tablet computer, an autonomous vehicle, an Internet of Things device, an edge device, or other computing systems on which inferencing operations can be performed (e.g., such as the processing system 500 illustrated in FIG. 5 and described in further detail below).

As illustrated, the operations 300 begin at block 310 with receiving an input including a set of tokens for processing by a transformer neural network. The input may be, for example, a set of tokens representing an input query provided by a user into the transformer neural network and optionally one or more tokens representing portions of an output generated during prior inferencing rounds in response to the input and previously generated output tokens.

At block 320, the operations 300 proceed with partitioning the set of tokens for processing by the transformer neural network into a first set of tokens and a second set of tokens.

In some aspects, the second set of tokens comprises a set of tokens generated over a most recent set of inferencing rounds performed by the transformer neural network, and the first set of tokens comprises a set of tokens generated in inferencing rounds prior to the most recent set of inferencing rounds. For example, given a window size of W and the generation of a single token in each inferencing round performed using the transformer neural network, the second set of tokens may include tokens generated over the W most recent inferencing rounds. The first set of tokens may include tokens generated prior to the beginning of the window W (that is, for t total inferencing rounds, tokens generate between the first and the t-W^{th} inferencing rounds, inclusive).

At block 330, the operations 300 proceed with generating, using at least one state space model, at least one compressed token representing the first set of tokens.

In some aspects, the state space model comprises a model trained to project a group of tokens (also referred to as a “chunk” or subset of tokens) into a single token representing the group of tokens based on minimizing a loss between a predicted token and a ground-truth token generated by the transformer neural network.

In some aspects, the at least one compressed token comprises a plurality of compressed tokens, each compressed token from the plurality of compressed tokens being generated by a unique state space model from a set of state space models including the state space model.

In some aspects, the at least one compressed token comprises a plurality of compressed tokens generated by the state space model, each respective compressed token being associated with a respective subset of tokens in the first set of tokens.

At block 340, the operations 300 proceed with generating, using the transformer neural network, an output token based on the at least one compressed token and the second set of tokens.

At block 350, the operations 300 proceed with generating a response to the input based on the output token.

In some aspects, the operations 300 further include appending the output token to the second set of tokens. The at least one compressed token may be updated based on an earliest token in the second set of tokens. A third set of tokens may be generated based on removing the earliest token in the second set of tokens from the second set of tokens. Using the transformer neural network, another output token may be generated based on the updated compressed token and the third set of tokens. Generally, the at least one compressed token may be updated in a recurrent manner as a function of the compressed token and the earliest token in the second set of tokens.

In some aspects, the set of tokens comprises a set of key-value pairs.

In some aspects, a key-value cache associated with the transformer neural network is sized based on a window size defining a number of tokens in the second set of tokens and a number of the at least one compressed tokens generated to represent the first set of tokens.

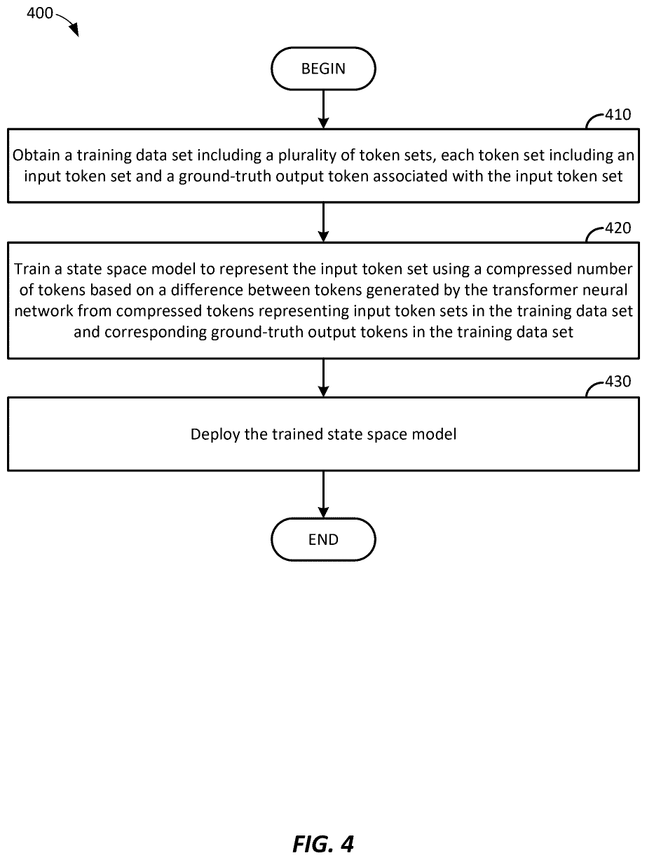

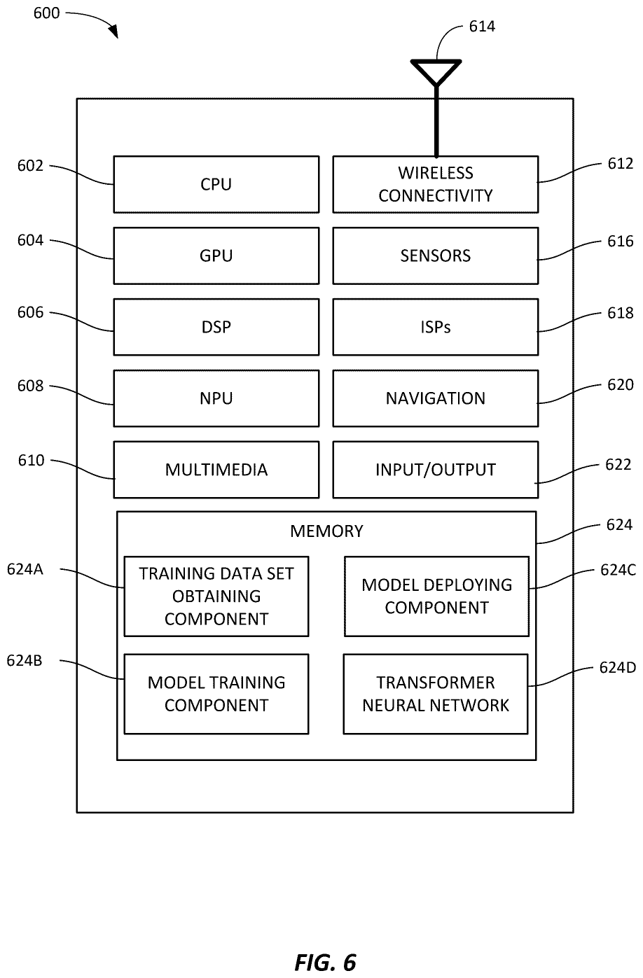

FIG. 4 illustrates example operations 400 for training a state space model to compress tokens prior to processing by a transformer neural network, according to certain aspects of the present disclosure. The operations 400 may be performed, for example, by a computing system on which one or more machine learning models (e.g., the SSM 120 illustrated in FIG. 1 and/or the SSMs 220 illustrated in FIG. 2) may be trained, such as a server computer, a cluster of physical or cloud computing instances, or other computing systems (e.g., such as the processing system 600 illustrated in FIG. 6 and described in further detail below).

As illustrated, the operations 400 begin at block 410, with obtaining a training data set including a plurality of token sets, each token set including an input token set and a ground-truth output token associated with the input token set. In some aspects, obtaining the training data set at block 410 may involve generating the training data set.

At block 420, the operations 400 proceed with training a state space model to represent the input token set using a compressed number of tokens based on a difference between tokens generated by the transformer neural network from compressed tokens representing input token sets in the training data set and corresponding ground-truth output tokens associated with the input token sets in the training data set.

At block 430, the operations 400 proceed with deploying the trained state space model. The deployed state space model may be used to generate at least one compressed token for an input token set that is input into the transformer neural network for inference generation.

In some aspects, parameters associated with the transformer neural network are frozen during training of the state space model.

In some aspects, the transformer neural network is a large language model configured to generate a textual response to a textual prompt. The input token set may correspond to at least an initial input prompt processed by the large language model, and the ground-truth output token may comprise a response token generated by the large language model in response to the input token set. In some aspects, the input token set may include the initial input prompt and one or more tokens generated by the large language model.

In some aspects, the transformer neural network is a large vision model configured to generate a response, such as an image, to a prompt including a request (and optionally a base image from which the response is to be generated). The input token set may correspond to a textual representation of the prompt (or request). The ground-truth output token may comprise an image generated in response to an input token set and a prompt input into the large vision model.

In some aspects, training the state space model at block 420 involves: (i) generating, using the state space model, a predicted token based on a state space model representation of the input token set; and (ii) minimizing a loss between the predicted token and a corresponding one of the tokens generated by the transformer neural network.

In some aspects, the operations 400 continue with using the deployed trained state space model to generate at least one compressed token for another input token set that is input into the transformer neural network for inference generation.

### Example Processing System for Inferencing Using Transformer Neural Networks and State-Space-Model-Based Token Compression

FIG. 5 depicts an example processing system 500 configured to perform various aspects of the present disclosure, including, for example, the techniques and methods described with respect to FIGS. 1-3. In some aspects, the processing system 500 may execute inferencing operations using a trained transformer-based machine learning model and a trained state space model that compresses tokens input into the transformer neural network, such as the state space model (SSM) 120 illustrated in FIG. 1 and/or the SSMs 220 illustrated in FIG. 2. Although depicted as a single system for conceptual clarity, in at least some aspects, as discussed above, the operations described below with respect to the processing system 500 may be distributed across any number of devices.

The processing system 500 includes a central processing unit (CPU) 502, which in some examples may be a multi-core CPU. Instructions executed at the CPU 502 may be loaded, for example, from a program memory associated with the CPU 502 or may be loaded from a partition of memory 524.

The processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation component 520, which may include satellite-based positioning system components (e.g., GPS or GLONASS) as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

In particular, in this example, the memory 524 includes an input receiving component 524A, a token set partitioning component 524B, a compressed token generating component 524C, an output token generating component 524D, a response generating component 524E, and machine learning models 524F (which, as discussed above, may include a transformer neural network and one or more state space models). Though depicted as discrete components for conceptual clarity in FIG. 5, the illustrated components (and others not depicted) may be collectively or individually implemented in various aspects.

Generally, the processing system 500 and/or components thereof may be configured to perform the methods described herein.

Notably, in other aspects, aspects of the processing system 500 may be omitted, such as where the processing system 500 is a server computer or the like. For example, the multimedia processing unit 510, the wireless connectivity component 512, the sensor processing units 516, the ISPs 518, and/or the navigation component 520 may be omitted in other aspects. Further, aspects of the processing system 500 may be distributed between multiple devices.

FIG. 6 depicts an example processing system 600 configured to perform various aspects of the present disclosure, including, for example, the techniques and methods described with respect to FIG. 4. In some aspects, the processing system 600 may train, implement, or provide a machine learning model, such as the state space model (SSM) 120 illustrated in FIG. 1 and/or the SSMs 220 illustrated in FIG. 2, for compressing a set of input tokens into one or more compressed tokens representing the data encoded in the set of input tokens for use in inferencing operations using a transformer neural network. Although depicted as a single system for conceptual clarity, in at least some aspects, as discussed above, the operations described below with respect to the processing system 600 may be distributed across any number of devices.

The processing system 600 includes a central processing unit (CPU) 602, which in some examples may be a multi-core CPU. Instructions executed at the CPU 602 may be loaded, for example, from a program memory associated with the CPU 602 or may be loaded from a partition of memory 624.

The processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation component 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a training data set obtaining component 624A, a model training component 624B, a model deploying component 624C, and a transformer neural network 624D. Though depicted as discrete components for conceptual clarity in FIG. 6, the illustrated components (and others not depicted) may be collectively or individually implemented in various aspects.

Generally, the processing system 600 and/or components thereof may be configured to perform the methods described herein.

Notably, in other aspects, elements of the processing system 600 may be omitted, such as where the processing system 600 is a server computer or the like. For example, the multimedia processing unit 610, the wireless connectivity component 612, the sensor processing units 616, the ISPs 618, and/or the navigation component 620 may be omitted in other aspects. Further, elements of the processing system 600 may be distributed between multiple devices.

### EXAMPLE CLAUSES

Implementation details of various aspects of the present disclosure are described in the following numbered clauses:

Clause 1: A processor-implemented method for machine learning, comprising: receiving an input including a set of tokens for processing by a transformer neural network; partitioning the set of tokens for processing by the transformer neural network into a first set of tokens and a second set of tokens; generating, using at least one state space model, at least one compressed token representing the first set of tokens; generating, using the transformer neural network, an output token based on the at least one compressed token and the second set of tokens; and generating a response to the input based on the output token.

Clause 2: The method of Clause 1, wherein the second set of tokens comprises a set of tokens generated over a most recent set of inferencing rounds performed by the transformer neural network and wherein the first set of tokens comprises a set of tokens generated in inferencing rounds prior to the most recent set of inferencing rounds.

Clause 3: The method of Clause 1 or 2, wherein the state space model comprises a model trained to project a group of tokens into a single token representing the group of tokens based on minimizing a loss between a predicted token and a ground-truth token generated by the transformer neural network.

Clause 4: The method of any of Clauses 1 through 3, further comprising: appending the output token to the second set of tokens; updating the at least one compressed token based on an earliest token in the second set of tokens; generating a third set of tokens based on removing the earliest token in the second set of tokens from the second set of tokens; and generating, using the transformer neural network, another output token based on the updated compressed token and the third set of tokens.

Clause 5: The method of any of Clauses 1 through 4, wherein the set of tokens comprises a set of key-value pairs.

Clause 6: The method of any of Clauses 1 through 5, wherein a key-value cache associated with the transformer neural network is sized based on a window size defining a number of tokens in the second set of tokens and a number of the at least one compressed tokens generated to represent the first set of tokens.

Clause 7: The method of any of Clauses 1 through 6, wherein the at least one compressed token comprises a plurality of compressed tokens, each compressed token from the plurality of compressed tokens being generated by a unique state space model from a set of state space models including the state space model.

Clause 8: The method of any of Clauses 1 through 6, wherein the at least one compressed token comprises a plurality of compressed tokens generated by the state space model, each respective compressed token being associated with a respective subset of tokens in the first set of tokens.

Clause 9: A processor-implemented method for machine learning, comprising: generating a training data set including a plurality of token sets, each token set including an input token set and a ground-truth token associated with the input token set; training a state space model to represent the input token set using a compressed number of tokens based on a difference between tokens generated by the transformer neural network from compressed tokens representing input token sets in the training data set and corresponding ground-truth tokens associated with input token sets in the training data set; and deploying the trained state space model.

Clause 10: The method of Clause 9, wherein parameters associated with the transformer neural network are frozen during training of the state space model.

Clause 11: The method of Clause 9 or 10, further comprising using the deployed trained state space model to generate at least one compressed token for another input token set that is input into the transformer neural network for inference generation.

Clause 12: The method of any of Clauses 9 through 11, wherein training the state space model comprises: generating, using the state space model, a predicted token based on a state space model representation of the input token set; and minimizing a loss between the predicted token and a corresponding one of the tokens generated by the transformer neural network.

Clause 13: The method of any of Clauses 9 through 12, wherein the transformer neural network comprises a large language model, wherein the input token set comprises an initial input prompt for processing by the large language model, and wherein the ground-truth token comprises a response token.

Clause 14: A processing system comprising: at least one memory comprising computer-executable instructions; and one or more processors configured to execute the computer-executable instructions and cause the processing system to perform a method in accordance with any of Clauses 1 through 13.

Clause 15: A processing system comprising means for performing a method in accordance with any of Clauses 1 through 13.

Clause 16: A non-transitory computer-readable medium comprising computer-executable instructions that, when executed by one or more processors of a processing system, cause the processing system to perform a method in accordance with any of Clauses 1 through 13.

Clause 17: A computer program product embodied on a computer-readable storage medium comprising code for performing a method in accordance with any of Clauses 1 through 13.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
at least one memory having executable instructions stored thereon; and
one or more processors configured to execute the executable instructions to cause the processing system to:
receive an input including a set of tokens for processing by a transformer neural network;
partition the set of tokens for processing by the transformer neural network into a first set of tokens and a second set of tokens;
generate, using at least one state space model, at least one compressed token representing the first set of tokens;
generate, using the transformer neural network, an output token based on the at least one compressed token and the second set of tokens; and
generate a response to the input based on the output token.

2. The processing system of claim 1, wherein the second set of tokens comprises a set of tokens generated over a most recent set of inferencing rounds performed by the transformer neural network and wherein the first set of tokens comprises a set of tokens generated in inferencing rounds prior to the most recent set of inferencing rounds.

3. The processing system of claim 1, wherein the state space model comprises a model trained to project a group of tokens into a single token representing the group of tokens based on minimizing a loss between a predicted token and a ground-truth token generated by the transformer neural network.

4. The processing system of claim 1, wherein the one or more processors are further configured to cause the processing system to:
append the output token to the second set of tokens;
update the at least one compressed token based on an earliest token in the second set of tokens;
generate a third set of tokens based on removing the earliest token in the second set of tokens from the second set of tokens; and
generate, using the transformer neural network, another output token based on the at least one updated compressed token and the third set of tokens.

5. The processing system of claim 4, wherein to update the at least one compressed token, the one or more processors are configured to cause the processing system to generate a new compressed token using the at least one compressed token and the earliest token in the second set of tokens as inputs into the state space model.

6. The processing system of claim 1, wherein the set of tokens comprises a set of key-value pairs.

7. The processing system of claim 1, wherein a key-value cache associated with the transformer neural network is sized based on a window size defining a number of tokens in the second set of tokens and a number of the at least one compressed token generated to represent the first set of tokens.

8. The processing system of claim 1, wherein the at least one compressed token comprises a plurality of compressed tokens, each compressed token from the plurality of compressed tokens being generated by a unique state space model from a set of state space models including the state space model.

9. The processing system of claim 1, wherein the at least one compressed token comprises a plurality of compressed tokens generated by the state space model, each respective compressed token being associated with a respective subset of tokens in the first set of tokens.

10. The processing system of claim 9, wherein each respective compressed token represents a number of tokens in the first set of tokens up to a threshold number of tokens.

11. A processing system comprising:
at least one memory having executable instructions stored thereon; and
one or more processors configured to execute the executable instructions to cause the processing system to:
generate a training data set including a plurality of token sets, each token set including an input token set and a ground-truth token associated with the input token set;
train a state space model to represent the input token set using a compressed number of tokens based on a difference between tokens generated by a transformer neural network from compressed tokens representing input token sets in the training data set and corresponding ground-truth tokens associated with input token sets in the training data set; and
deploy the trained state space model.

12. The processing system of claim 11, wherein parameters associated with the transformer neural network are frozen while the state space model is trained.

13. The processing system of claim 11, wherein the deployed trained state space model is used to generate at least one compressed token for another input token set that is input into the transformer neural network for inference generation.

14. The processing system of claim 11, wherein to train the state space model, the one or more processors are configured to cause the processing system to:
generate, using the state space model, a predicted token based on a state space model representation of the input token set; and
minimize a loss between the predicted token and a corresponding one of the tokens generated by the transformer neural network.

15. The processing system of claim 11, wherein the transformer neural network comprises a large language model, wherein the input token set comprises an initial input prompt for processing by the large language model, and wherein the ground-truth token comprises a response token.

16. A processor-implemented method for machine learning, comprising:
receiving an input including a set of tokens for processing by a transformer neural network;
partitioning the set of tokens for processing by the transformer neural network into a first set of tokens and a second set of tokens;
generating, using a state space model, at least one compressed token representing the first set of tokens;
generating, using the transformer neural network, an output token based on the at least one compressed token and the second set of tokens; and
generating a response to the input based on the output token.

17. The method of claim 16, wherein the second set of tokens comprises a set of tokens generated over a most recent set of inferencing rounds performed by the transformer neural network and wherein the first set of tokens comprises a set of tokens generated in inferencing rounds prior to the most recent set of inferencing rounds.

18. The method of claim 16, wherein the state space model comprises a model trained to project a group of tokens into a single token representing the group of tokens based on minimizing a loss between a predicted token and a ground-truth token generated by the transformer neural network.

19. The method of claim 16, further comprising:
appending the output token to the second set of tokens;
updating the at least one compressed token based on an earliest token in the second set of tokens;
generating a third set of tokens based on removing the earliest token in the second set of tokens from the second set of tokens; and
generating, using the transformer neural network, another output token based on the at least one updated compressed token and the third set of tokens.

20. The method of claim 19, wherein updating the at least one compressed token comprises generating a new compressed token using the at least one compressed token and the earliest token in the second set of tokens as inputs into the state space model.

21. The method of claim 16, wherein the set of tokens comprises a set of key-value pairs.

22. The method of claim 16, wherein a key-value cache associated with the transformer neural network is sized based on a window size defining a number of tokens in the second set of tokens and a number of the at least one compressed token generated to represent the first set of tokens.

23. The method of claim 16, wherein the at least one compressed token comprises a plurality of compressed tokens, each compressed token from the plurality of compressed tokens being generated by a unique state space model from a set of state space models including the state space model.

24. The method of claim 16, wherein the at least one compressed token comprises a plurality of compressed tokens generated by the state space model, each respective compressed token being associated with a respective subset of tokens in the first set of tokens.

25. The method of claim 24, wherein each respective compressed token represents a number of tokens in the first set of tokens up to a threshold number of tokens.

26. A processor-implemented method for machine learning, comprising:
obtaining a training data set including a plurality of token sets, each token set including an input token set and a ground-truth token associated with the input token set;
training a state space model to represent the input token set using a compressed number of tokens based on a difference between tokens generated by a transformer neural network from compressed tokens representing input token sets in the training data set and corresponding ground-truth tokens associated with the input token sets in the training data set; and
deploying the trained state space model.

27. The method of claim 26, wherein parameters associated with the transformer neural network are frozen during the training of the state space model.

28. The method of claim 26, further comprising using the deployed trained state space model to generate at least one compressed token for another input token set that is input into the transformer neural network for inference generation.

29. The method of claim 26, wherein training the state space model comprises:
generating, using the state space model, a predicted token based on a state space model representation of the input token set; and
minimizing a loss between the predicted token and a corresponding one of the tokens generated by the transformer neural network.

30. The method of claim 26, wherein the transformer neural network comprises a large language model, wherein the input token set comprises an initial input prompt for processing by the large language model, and wherein the ground-truth token comprises a response token.
